(19) United States
(12) Patent Application Publication
(10) Pub. No.: US 2015/0099545 A1
(43) Pub. Date: Apr. 9, 2015

(54) LOCATION INFORMATION-BASED COMMUNICATION APPARATUS AND METHOD, AND LOCATION INFORMATION-BASED COMMUNICATION APPLICATION APPARATUS

(71) Applicant: Sang Soo Hyun, Youngin-Si (KR)

(72) Inventor: Sang Soo Hyun, Youngin-Si (KR)

(21) Appl. No.: 14/402,172

(22) PCT Filed: May 25, 2012
(86) PCT No.: PCT/KR2012/004157

§ 371 Date: Nov. 19, 2014

(51) Int. Cl. H04W 4/02

(52) U.S. Cl. CPC H04W 4/02
USPC 455/456.3

(57) ABSTRACT

A location information-based communication apparatus and method are disclosed. The location information-based communication apparatus includes a transmission terminal, a communication control unit, a local terminal location storage unit, and reception target terminals. The transmission terminal transmits information about a call connection location selected by a user to the communication control unit, outputs a list of information about one or more reception target terminals which are present around the call connection location on a screen, and transmits a call signal to the communication control unit. The communication control unit receives the list of the reception target terminals from a local terminal location storage unit, transmits the list of information about the reception target terminals to the transmission terminal, and connects the transmission terminal to desired reception target terminals by connecting to phone numbers of the reception target terminals over a wired or wireless communication network.

### TECHNICAL FIELD

The present invention relates, in general, to a location information-based communication apparatus and method and a location information-based communication application apparatus, and, more particularly, to a location information-based communication apparatus and method and a location information-based communication application apparatus, which enable the user of a communication terminal to make a call or exchange a text message with one or more target recipients who are present at a specific location.

### BACKGROUND ART

With the recent development of Information Technology (IT), a variety of types of communication methods have been provided.

A typical wireless communication method is a method of communicating using mobile phones, in which a transmitter inputs and dials the phone number of a mobile phone carried by a recipient (connects a call) and then a communication company places a phone call to the corresponding phone number, so that the transmitter can communicate with the recipient using the mobile phone.

However, since most of the conventional communication methods use the unique phone number (or connection number) of a terminal to perform connection and communication, there has been a problem in that it is difficult to place a call to a terminal owner who is present at a specific region.

For example, when a festival takes place in Haeundae of Busan, there has been no method for enabling a user who lives in Seoul to place a call to a specific person who is currently enjoying the festival in Haeundae of Busan, so that a problem arises in that the user who lives in Seoul should obtain information about the corresponding festival via news or obtain limited picture information provided over the Internet.

### DISCLOSURE

### Technical Problem

Accordingly, the present invention has been made keeping in mind the above problems occurring in the prior art, and an object of the present invention is to provide a location information-based communication apparatus and method and a location information-based communication application apparatus, in which a transmitter inputs information about a desired call connection location using a terminal, and in which a system provides a list of reception target terminals around the information about the call connection location (reception target location) to a transmitter terminal, so that the transmitter can communicate with a plurality of random reception target terminals which are present around the call connection location.

### Technical Solution

In order to accomplish the above object, the present invention provides a location information-based communication method including a first step in which the communication control unit of a communication company receives information about a call connection location (reception target location information) used for call connection from a transmission terminal; a second step in which the communication control unit requests a list of information about reception target terminals, which exist around a call connection location corresponding to the information about the call connection location, from a local terminal location storage unit which is in charge of the corresponding call connection location, and the communication control unit receives the list of information about the reception target terminals, which has been transmitted from the local terminal location storage unit in response to the request; a third step in which the communication control unit transmits the list of information about the reception target terminals, which was received in the second step, to the transmission terminal and waits for reception of a call signal; and a fourth step in which the communication control unit receives the call signal transmitted in such a way that the user of the transmission terminal selects any one or more reception target terminals from the list of information about the reception target terminals, and connects the transmission terminal to the reception target terminals by connecting to the phone numbers of the reception target terminals which correspond to the received call signal over a wired or wireless communication network.

### Advantageous Effects

According to the present invention, a transmission terminal user can select any one of a plurality of random reception target terminals which are present around a call connection location, and can place a call or transmit a text message to the selected reception target terminal by using location information as a call signal, so that a transmitter can check the situation of a specific region and can receive image information about the corresponding region through a recipient who is present at the corresponding location, thereby expecting the advantage of enabling the user to conveniently and exactly receive various types of information about a desired region. Further, a call can be made using various types of communication methods between terminals in which the location information-based communication applications are respectively installed, thereby obtaining the advantage of enabling information to be exchanged with terminals, such as a navigation unit, a vehicle's black box, and a wired terminal, which have a communication function while such a terminal is not limited to a mobile phone or a smart phone.

### DESCRIPTION OF DRAWINGS

The above and other objects, features and advantages of the present invention will be more clearly understood from the following detailed description taken in conjunction with the accompanying drawings, in which:

FIG. 1 is a block diagram illustrating a hardware configuration according to a first embodiment in order to implement the present invention;

FIG. 2 is a flowchart illustrating a communication method according to the first embodiment of the present invention;

FIG. 3 is a view illustrating a process of preparing a list of reception target terminals using location information according to the present invention;

FIG. 4 is a view illustrating an example of data stored in a local terminal location storage unit;

FIG. 5 is a view illustrating the list of wireless terminals displayed on the screen of a transmission terminal according to the present invention;

FIG. 6 is a block diagram illustrating a hardware configuration according to a second embodiment in order to implement the present invention;

FIG. 7 is a flowchart illustrating a communication method according to the second embodiment of the present invention;

FIG. 8 is a view illustrating a location information input screen displayed on the screen of the transmission terminal according to the present invention;

FIG. 9 is a view illustrating a communication method selection screen;

FIG. 10 is a view illustrating the configuration of a location information-based communication application apparatus according to a third embodiment of the present invention;

FIG. 11 is a view illustrating the configuration of a location information-based communication application applied to the third embodiment of the present invention;

FIG. 12 is a view illustrating the configuration of a location information input application applied to the third embodiment of the present invention;

FIG. 13 is a view illustrating a location information input selection screen activated in the screen of a terminal by the location information-based communication application according to the third embodiment;

FIG. 14 is a view illustrating a coordinate input mode which is output on the screen of the terminal by the location information input application according to the third embodiment;

FIG. 15 is a view illustrating an address input mode which is output on the screen of the terminal by the location information input application according to the third embodiment;

FIG. 16 is a view illustrating a road name input mode which is output on the screen of the terminal by the location information input application according to the third embodiment;

FIG. 17 is a view illustrating a building name input mode which is output on the screen of the terminal by the location information input application according to the third embodiment;

FIG. 18 is a view illustrating a map input mode which is output on the screen of the terminal by the location information input application according to the third embodiment;

FIG. 19 is a view illustrating a reception target field selection screen which is output on the screen of the terminal by a reception target field selection application according to the third embodiment;

FIG. 20 is a view illustrating a communication method selection screen which is output on the screen of the terminal by a communication method selection application;

FIG. 21 is a view illustrating a reception screen which is output on the screen of the terminal by a reception application;

FIG. 22 is a view illustrating a text message which is transmitted from a transmission terminal and is output on the screen of a reception terminal; and

FIG. 23 is a view illustrating a communication system used to implement the communication application apparatus according to the present invention.

### MODE FOR INVENTION

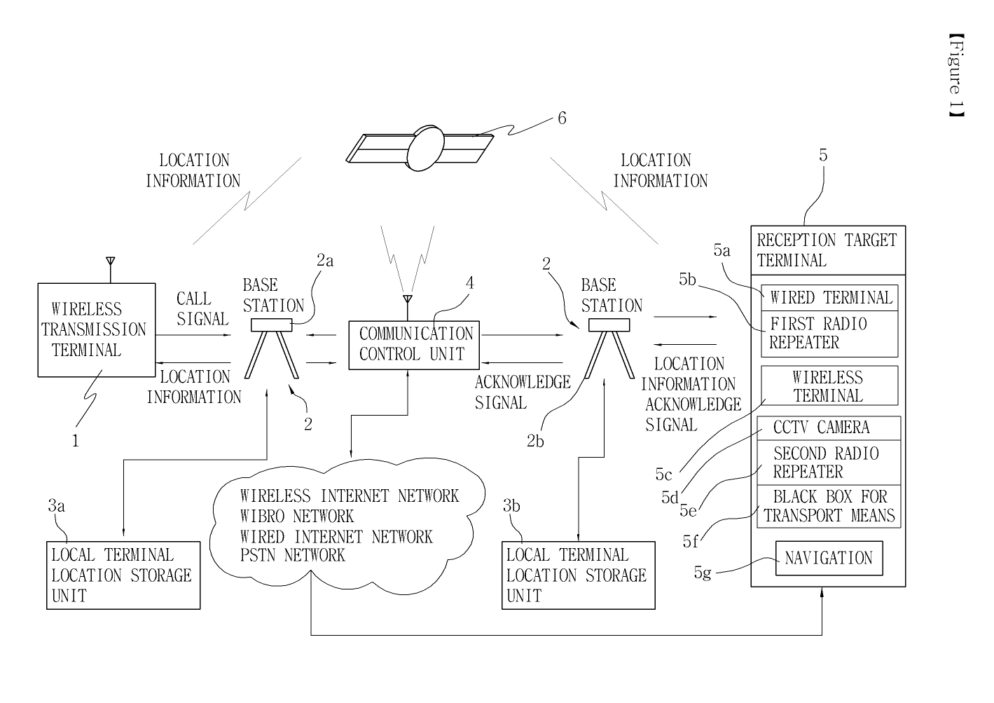

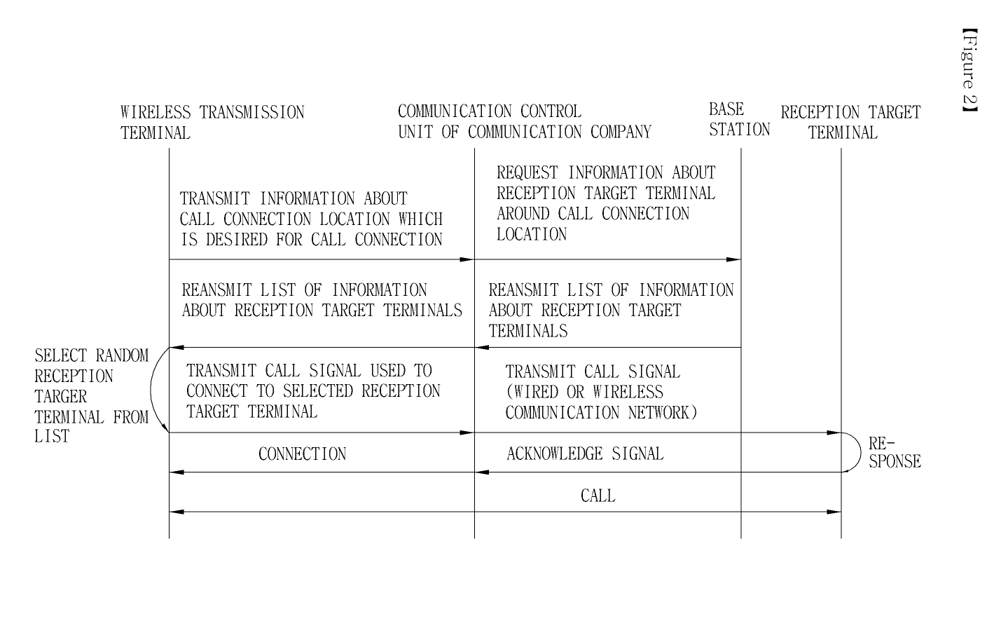

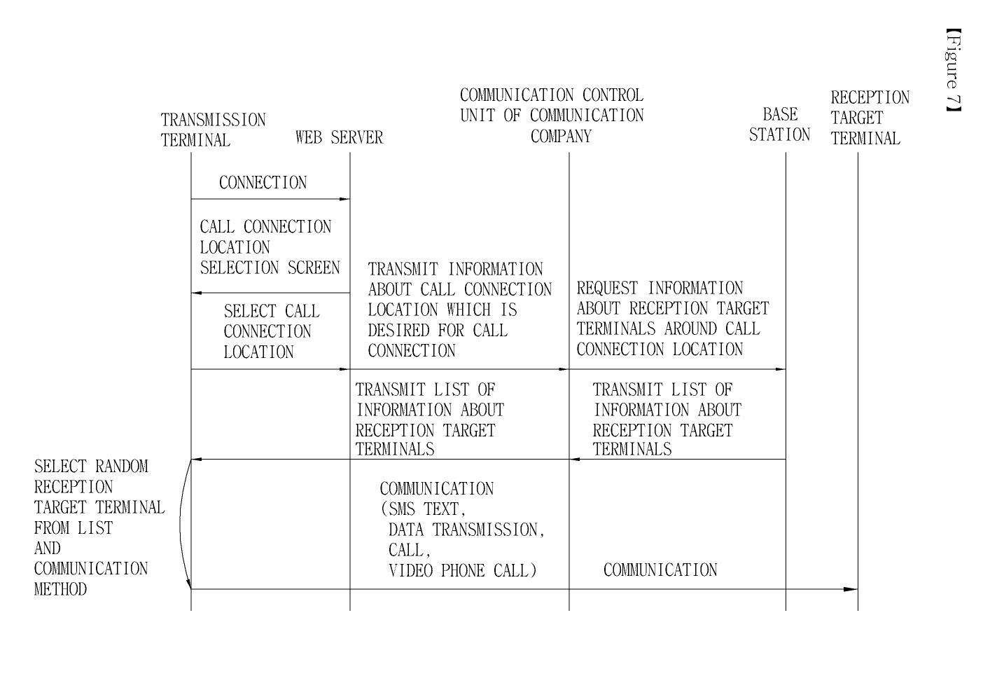

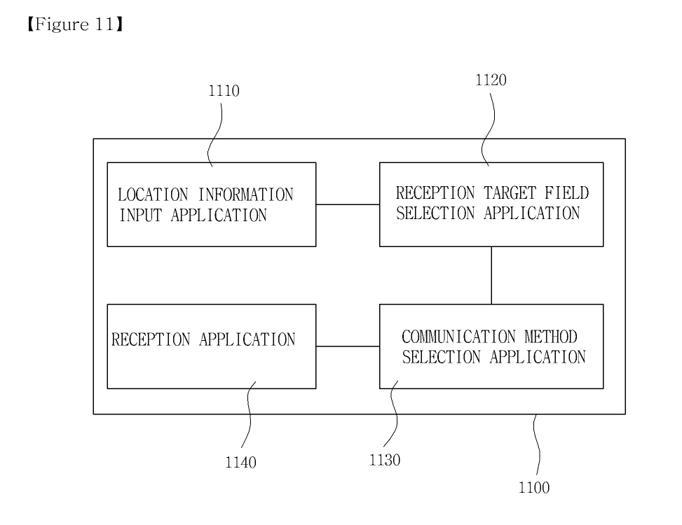

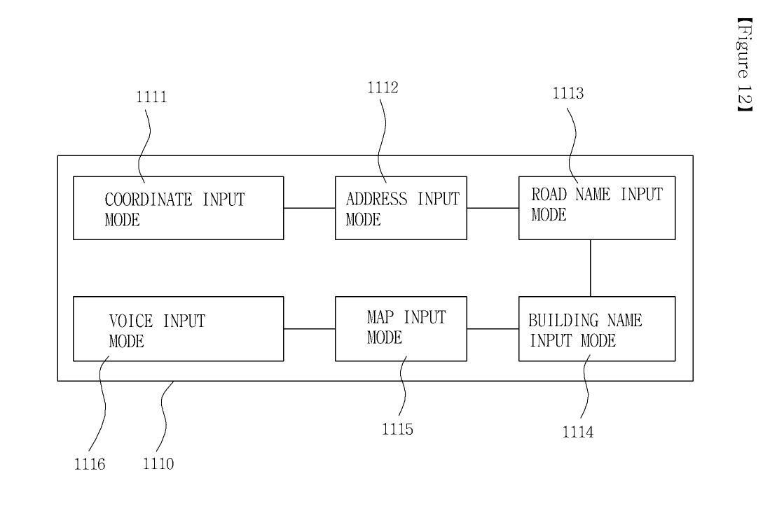

Preferred embodiments of the present invention will be described with reference to FIGS. 1 to 23 below.

Since terms defined to describe the present invention are defined after taking into consideration the functions thereof according to the present invention, the terms should not be understood in such a way that they limit the technical elements of the present invention. Since the present invention may be divided into three embodiments, the present invention will now be described using the embodiments.

### First Embodiment

A first embodiment includes a transmission terminal 1 for transmitting information about a call connection location which is selected by a user to a communication control unit 4, outputting a list of information about one or more reception target terminals, which are present around the call connection location received from the communication control unit 4, onto a screen, and transmitting a call signal which targets any one or one or more reception target terminals 5 selected from the list of information about the reception target terminals to the communication control unit 4; the communication control unit 4 for receiving a list of the reception target terminals 5, which are present around the call connection location corresponding to the information about the call connection location received from the transmission terminal 1, from a local terminal location storage unit 3 which is in charge of a relevant reception target location, transmitting the list of information about the reception target terminals 5 to the transmission terminal 1, and connecting the transmission terminal 1 to desired reception target terminals 5 by connecting to the phone numbers of the reception target terminals 5 which correspond to the call signal transmitted from the transmission terminal 1 over a wired or wireless communication network; a local terminal location storage unit 3 for receiving pieces of location information which have been received from reception target terminals 5 which are present within a local area in each predetermined period via a base station 2, storing the pieces of location information, generating the list of information about the reception target terminals by collecting the reception target terminals which are present within the set radius around the call connection location (reception target location) corresponding to the information about the call connection location when the information about the call connection location is received from the communication control unit 4, and transmitting the generated list of information about the reception target terminals to the communication control unit 4; and the reception target terminals 5 for each receiving location information which is transmitted from satellites 6 and transmitting the location information to the base station 2.

A location information-based communication method implemented using the above-described hardware includes a first step in which the communication control unit 4 of a communication company receives information about a call connection location, used for call connection, from the transmission terminal 1; a second step in which the communication control unit 4 requests a list of reception target terminals 5, which are present around the call connection location corresponding to the information about the call connection location, from the local terminal location storage unit 3 which is in charge of the call connection location, and receives the list of information about the reception target terminals, which has been transmitted from the local terminal location storage unit 3 in response to the request; a third step in which the communication control unit 4 transmits the list of information about the reception target terminals, which was received in the second step, to the transmission terminal 1 and waits for the reception of a call signal; and a fourth step in which the communication control unit 4 receives the call signal, which is transmitted in such a way that a user of the transmission terminal 1 selects any one of the reception target terminals 5 from the list of information about the reception target terminals, and connects the transmission terminal to the reception target terminal 5 by connecting to the phone number of the reception target terminal 5 corresponding to the received call signal over a wired or wireless communication network.

Further, the local terminal location storage unit 3 receives pieces of location information which have been received from the reception target terminals 5 which are present in the local area in each predetermined period via the base station 2, stores the pieces of location information, generates the list of information about the reception target terminals by collecting the reception target terminals which are present within the set radius around the call connection location corresponding to the information about the call connection location when the information about the call connection location is received from the communication control unit 4, and transmits the list of information about the reception target terminals to the communication control unit 4.

Further, each of the reception target terminals 5 includes any one of a wired terminal 5a connected to a first radio repeater 5b which can communicate with the base station 2, which can receive Global Positioning System (GPS) location information from satellites, and which can transmit the GPS location information to the base station 2; a wireless terminal 5c which can receive GPS location information from satellites and can make a call; a Closed-Circuit Television (CCTV) camera 5d connected to a second radio repeater 5e which can communicate with the base station 2, which can receive GPS location information from satellites, which can transmit the GPS location information to the base station 2, and which has received a phone number used for call connection; and a navigation unit 5f which can receive GPS location information from satellites, and which can make a wireless call.

The first radio repeater 5b performs the function of receiving GPS location information from satellites and transmitting the GPS location information to the base station 2, and the wired terminal 5a is a normal wired phone or an Internet phone which makes a call over a Public Switched Telephone Network (PSTN) or an Internet network.

Further, the second radio repeater 5e is configured to wirelessly transmit image information captured by the CCTV camera 5d to the transmission terminal 1 when the transmission terminal 1 is connected via the base station.

When the communication control unit 4 requests the list of the reception target terminals which are present around the call connection location from the local terminal location storage unit 3 and the response of the local terminal location storage unit 3 is that there is no reception target terminal 5 within the set radius around the corresponding call connection location, the communication control unit 4 requests that the local terminal location storage unit 3 extend the set radius by a predetermined distance, so that the local terminal location storage unit 3 extends the set radius around the call connection location in response to the request from the communication control unit 4, generates a list of reception target terminals which are present within the set radius, and transmits the generated list to the communication control unit 4.

Further, the information about the call connection location is any one of address information and location coordinates (X, Y) including latitude and longitude.

In order to promote technical understanding, the first embodiment is described using an example wherein the location of the transmission terminal 1 is separate from the reception target location terminal 5, the transmission terminal 1 communicates with a first base station 2a, the reception target terminal 5 communicates with a second base station 2b, and the first base station 2a and second base station 2b are connected to respective local terminal location storage units 3a and 3b which are different from each other.

The operation of the present invention which is configured as described above will be described below.

First, when a user who uses the transmission terminal 1 wants to know about a festival which is taking place at a specific area, the user transmits information about the call connection location of a region where the festival is taking place to the communication control unit 4 via the base station 2a.

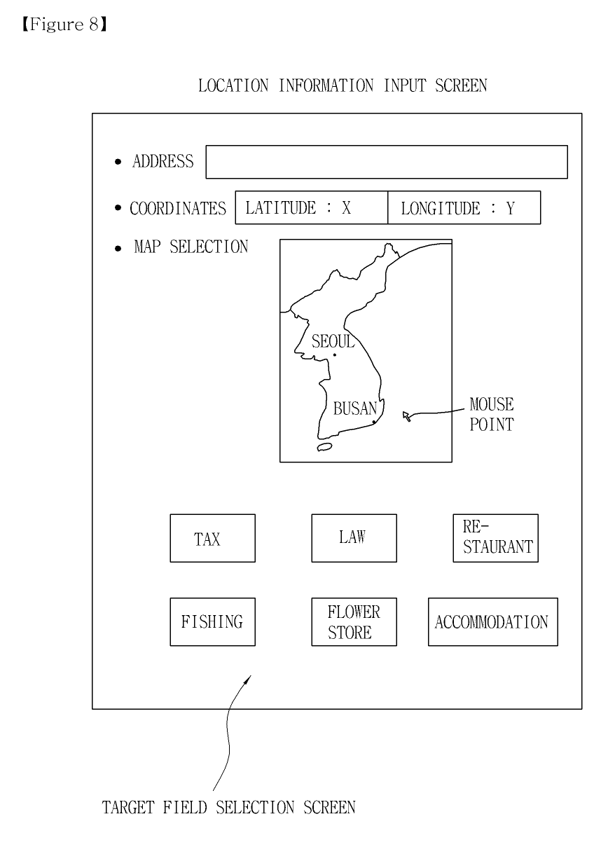

The information about the call connection location used for call connection is transmitted in such a way that the user inputs address information using a call connection location information input screen (refer to FIG. 8) which is displayed on the transmission terminal 1 or inputs the location coordinates (latitude-X and longitude-Y) of a corresponding region.

As another input method for inputting the information about the call connection location, the information about the call connection location is transmitted in such a way that a map in which a location can be selected is output on the screen of the transmission terminal 1, and the user selects the location of a desired region on the map.

When the information about the call connection location used for call connection is transmitted from the transmission terminal 1, the communication control unit 4 of the communication company receives the information about the call connection location via the first base station 2a, and then requests that the local terminal location storage unit 3, which is in charge of the corresponding call connection location, transmit a list of reception target terminals 5 which are present within the set radius around the call connection location (the reception target location) corresponding to the information about the call connection location. Thereafter, the communication control unit 4 receives the list of information about the reception target terminals, which was transmitted by the local terminal location storage unit 3 in response to the request.

When the communication control unit 4 transmits the information about the call connection location to all the base stations 2, a local terminal location storage unit, which is in charge of a local area including the corresponding call connection location, from among the local terminal location storage unit 3 which are connected to the corresponding base stations 2, that is, a local terminal location storage unit 3b which is connected to the second base station 2b in the present invention operates such that a list of reception target terminals which are present within the set radius around the call connection location is generated and transmitted to the communication control unit 4.

The operation of the local terminal location storage unit 3 will now be described in further detail.

Generally, each wireless terminal 5c receives GPS location information from a GPS satellite 6 and then transmits the location information to the base station 2 in a local area in each predetermined period.

In the present invention, the reception target terminal 5 is extended into the wired terminal 5a, the CCTV camera 5d, the navigation unit 5f, a black box for transport means 5g, a mobile phone, a smart phone, a tablet Personal Computer (PC), and a notebook computer as well as the wireless terminals 5c.

The wired terminal 5a, the CCTV camera 5d, and the black box for transport means 5g are connected to the separate first and second radio repeaters 5b in order to transmit the GPS location information to the base station 2. Meanwhile, the navigation unit 5f can autonomously perform wireless communication and can transmit the GPS location information to the base station 2.

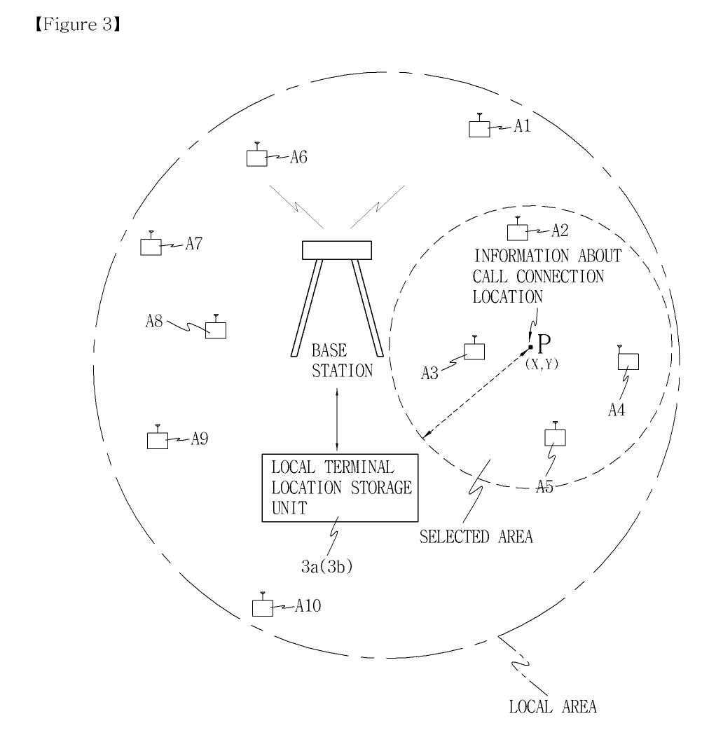

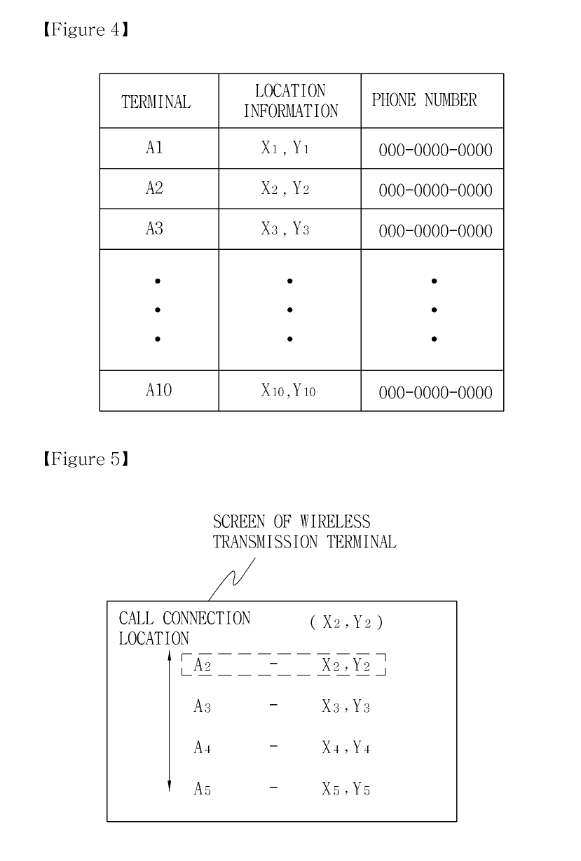

In this situation, if it is assumed that a plurality of reception target terminals A1 to A10 are present within a local area that the base station 2 is in charge of as shown in FIG. 3, the reception target terminals A1 to A10 transmit the pieces of location information which have been received from the satellite 6 to the base station 2 at every predetermined period. Thereafter, the local terminal location storage unit 3 which is connected to the base station 2 stores the pieces of location information, which have been received from the reception target terminals A1 to A10 via the base station, 2 as shown in FIG. 4.

FIG. 4 illustrates an example in which the pieces of location information of the reception target terminals A1 to A10 are stored using X and Y coordinates, and the phone numbers of the corresponding reception target terminals A1 to A10 are stored together with the location information.

If the information about the call connection location (X, Y) is transmitted from the communication control unit 4 in the state in which the pieces of location information of the reception target terminals A1 to A10 which are present within the local area are stored in the local terminal location storage unit 3, the local terminal location storage unit 3 determines that a location corresponding to the information about the call connection location is included in the local area of the base station 2, finds the reception target terminals A2 to A5 which are present within the set radius (selected area) based on the corresponding call connection location (X, Y), generates a list of data about the reception target terminals A2 to A5, and transmits the list of data to the communication control unit 4.

It is preferable that the set radius be set to 100 m to 300 m, and the set radius may be extended.

Meanwhile, if, when the local terminal location storage unit 3 which received the information about the call connection location from the communication control unit 4 searches for reception target terminals which are present within the set radius around the corresponding call connection location, it is determined that there is no reception target terminal within the set radius, the local terminal location storage unit 3 notifies the communication control unit 4 that there is no reception target terminal which can be talked to around the call connection location. Thereafter, the communication control unit 4 requests that the set radius be extended by a predetermined distance from the local terminal location storage unit 3. The local terminal location storage unit 3 extends the set radius around the call connection location in response to the request from the communication control unit 4, generates a list of reception target terminals which are present within the set radius, and transmits the list of the reception target terminals to the communication control unit 4.

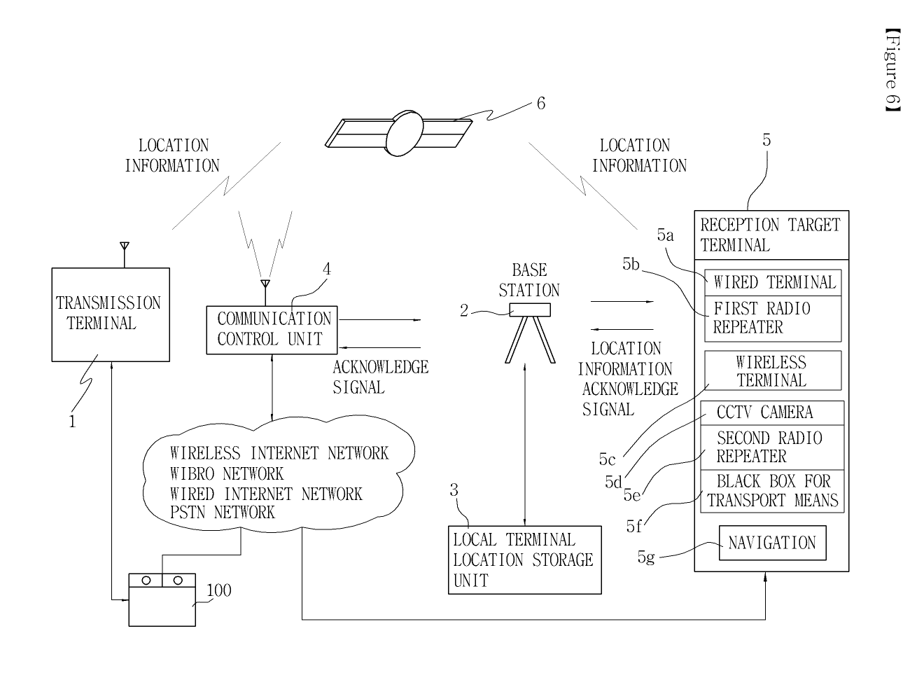

As described above, when the list of the reception target terminals which are present within the set radius around the call connection location is received by the communication control unit 4 from the local terminal location storage unit 3, the communication control unit 4 transmits the received list of the reception target terminals to the transmission terminal 1 via the first base station 2a, the list of the reception target terminals, which was transmitted from the communication control unit 4, is displayed on the screen of the transmission terminal 1 as shown in FIG. 5

In the state in which the list of the reception target terminals is displayed on the screen of the transmission terminal 1 as shown in FIG. 5, the user selects any one of the reception target terminals from the list of the reception target terminals by operating up and down movement keys (not shown) provided in the transmission terminal 1.

If a touch screen function is provided to the transmission terminal 1, the user selects the corresponding reception target terminal by touching any one of the reception target terminals from the list of the reception target terminals using his or her finger.

If the user selects any one of the reception target terminals by operating the transmission terminal 1 and call connection to the selected reception target terminal 5 is requested, a call signal is transmitted to the communication control unit 4 via the first base station 2a, and the communication control unit 4 dials the phone number of the reception target terminal 5 such that the call signal is transmitted to the reception target terminal 5.

The communication control unit 4 operates such that the call signal is transmitted to the reception target terminal 5 over a wireless Internet network, a Wireless Broadband Internet (WiBro) network, a wired Internet network, a PSTN, or a wireless communication network based on the communication method of the reception target terminal 5.

When the reception target terminal 5 receives the call signal, a ringtone is generated in the reception target terminal 5. If a recipient who is aware of the ringtone responds by operating the reception target terminal 5, a response signal is transmitted to the communication control unit 4 over a wired or wireless communication network, so that the transmission terminal 1 and the reception target terminal 5 are connected to each other, thereby enabling a call to be made.

The user of the transmission terminal 1 connected to the reception target terminal 5 which is present around the specific region (call connection location), that is, the transmitter can obtain information while directly asking about the current situation occurring in the specific region. Further, in the case of a terminal capable of making a video phone call, the transmitter can check images around the region, so that the transmitter can obtain more accurate information.

Further, the transmitter can check images captured by a CCTV using a wireless terminal by connecting to the CCTV installed in the specific region.

When the above-described communication method according to the present invention, in which location information is used as a call signal, is used, the advantage of a long-distance user being able to rapidly and quickly obtain detailed information about a festival which is taking place in another region or a big accident can be obtained.

### Second Embodiment

When a second embodiment is described, the same reference numerals are used to designate the same configurations as those of the first embodiment, and repetitive portions of the description are avoided.

The hardware configuration of the second embodiment includes a transmission terminal 1 capable of performing wired or wireless Internet communication, accessing a web server 100 over the Internet, selecting one or more reception target terminals from a list of information about reception target terminals, which is provided from the web server 100, and a communication method used to communicate with the selected reception target terminals, transmitting the selected reception target terminals and the communication method to the web server 100, and communicating with the reception target terminals 5 connected by the web server 100; the web server 100 for providing a call connection location information input screen, which enables information about a call connection location to be input or selected, to the transmission terminal 1 which has been accessed over the Internet, transmitting the information about the call connection location, which was input using the call connection location information input screen, to the communication control unit 4, outputting a list of information about reception target terminals which are present around the call connection location to the screen of the transmission terminal 1, the list of information about the reception target terminals being transmitted from the communication control unit 4, and transmitting a call signal, which targets any one or more reception target terminals 5 which are selected from the list of the information about the reception target terminals using the transmission terminal 1, to the communication control unit 4; the communication control unit 4 for receiving the list of information about the reception target terminals which are present around the call connection location corresponding to the information about the call connection location, the list being transmitted from the web server 100, from the local terminal location storage unit 3 which is in charge of the corresponding reception target location, and transmitting the list of information about the reception target terminals to the web server 100, and connecting the transmission terminal 1 to the reception target terminals 5 by accessing the phone numbers of the reception target terminals 5 which correspond to the call signal transmitted from the web server 100 over a wired or wireless communication network; the local terminal location storage unit 3 for receiving and storing pieces of location information which have been transmitted from the reception target terminals 5 which are present within a local area in each predetermined period via the base station 2, and, if the information about the call connection location is transmitted from the communication control unit 4, collecting the reception target terminals which are present within the set radius around a call connection location (reception target location) corresponding to the information about the call connection location, generating the list of information about the reception target terminals, and transmitting the list of information about the reception target terminals to the communication control unit 4; and the reception target terminals 5 for receiving the location information transmitted from a satellite 6, and transmitting the location information to the base station 2.

A location information-based communication method implemented using the above-described hardware configuration includes a first step in which a web server 100 transmits a call connection location information input screen, which enables information about a call connection location used for call connection to be input or selected, to the transmission terminal 1 of a user, which has accessed the web server 100 over the Internet; a second step in which the web server 100 receives the information about the call connection location, which was input or selected by the user using the call connection location information input screen, transmits the information about the call connection location to a communication control unit 4, and requests a list of information about reception target terminals; a third step in which the communication control unit 4 receives the list of information about the reception target terminals from the local terminal location storage unit 3 and transmits the received list of information about the reception target terminals to the web server 100 at the request of the web server 100, and in which the web server 100 transmits the received list of information about the reception target terminals to the transmission terminal 1; and a fourth step in which the web server 100 receives information which had been transmitted in such a way that the user selects a single reception target terminal or a plurality of reception target terminals using the list of information about the reception target terminals and selects a desired communication method, and in which the web server 100 transmits information using any one communication method selected by the user from among a text message, a phone call, and data communication, to the reception target terminals selected by the user or enables a call is made.

If the communication method selected by the user in the fourth step is Short Message Service (SMS) text message transmission, the web server 100 provides an input screen which enables the user to input a text message, and transmits the text message which was input using the input screen to the communication control unit 4 such that the text message is transmitted to the reception target terminals.

The transmission terminal 1 is a terminal capable of performing wired or wireless Internet communication, and includes any one of a mobile phone, a Personal Computer (PC), a Personal Digital Assistant (PDA), a smart phone, a tablet PC, and a satellite phone.

The local terminal location storage unit 3 receives pieces of location information which are received from the reception target terminals 5 which are present in the local area in each predetermined period via the base station 2, stores the location information, generates the list of information about the reception target terminals by collecting reception target terminals which are present within the set radius around the call connection location corresponding to the information about the call connection location when the information about the call connection location is received from the communication control unit 4, and transmits the list of information about reception target terminals to the communication control unit 4.

Further, each of the reception target terminals 5 includes any one of a wired terminal 5a connected to a first radio repeater 5b which can communicate with the base station 2, which can receive Global Positioning System (GPS) location information from satellites, and which can transmit the GPS location information to the base station 2; a wireless terminal 5c which can receive GPS location information from satellites and can make a call; a CCTV camera 5d connected to a second radio repeater 5e which can communicate with the base station 2, which can receive GPS location information from satellites, which can transmit the GPS location information to the base station 2, and which has received a phone number used for call connection; a navigation unit 5f which can receive GPS location information from satellites, and which can make a wireless call; and a black box for transport means 5g which is provided with a camera and which is connected to the second radio repeater 5e which can communicate with the base station 2, which can receive GPS location information from satellites, which can transmit the GPS location information to the base station 2, and which has received the phone number used for call connection.

The first radio repeater 5b performs the function of receiving the GPS location information from satellites and transmitting the GPS location information to the base station 2, and the wired terminal 5a is a normal wired phone or an Internet phone which makes a call over a PSTN or an Internet network.

Further, the second radio repeater 5e is configured to wirelessly transmit image information captured by the CCTV camera 5d to the transmission terminal 1 when the transmission terminal 1 is connected via the base station.

The operation according to the second embodiment which is configured as described above will be described below.

First, a user accesses the web server 100 over the Internet using the transmission terminal 1, and the web server 100 provides the location information input screen as shown in FIG. 8 to the transmission terminal 1.

The location information input screen includes an address input window which enables the user to directly input an address, a coordinate input window which enables location data including latitude and longitude to be input, and a map selection window which enables the user to perform selection using a map. The user inputs coordinates or an address corresponding to a desired location using the location information input screen, or selects the desired location using a map screen provided on the map selection window.

Meanwhile, the call connection location information input screen includes a target field selection screen which enables the user to select the target field (category) of a desired recipient in order to perform communication.

The target field selection screen displays field pop-up windows (tax, accommodation, sports, and restaurant) which indicate various types of fields. When a specific field pop-up window is selected by the user, the web server 100 provides a list of information about reception targets, which have been registered in a relevant field in advance at a location corresponding to the information about the call connection location selected by the user, to the transmission terminal 1.

When the user selects a desired call connection location using the transmission terminal 1, the web server 100 which received the information about the call connection location transmits the information about the call connection location to the communication control unit 4.

When the information about the call connection location used for call connection is received, the communication control unit 4 of a communication company requests that the local terminal location storage unit 3, which is in charge of the corresponding call connection location, transmit a list of reception target terminals 5 which are present within the set radius around the call connection location corresponding to the information about the call connection location. Thereafter, the communication control unit 4 receives the list of information about the reception target terminals, which is transmitted from the local terminal location storage unit 3 at the request of the control unit 4.

The communication control unit 4 transmits the information about the call connection location to all the base stations 2. A local terminal location storage unit 3, which is in charge of a local area including the corresponding call connection location and which is selected from among local terminal location storage units which are connected to the corresponding base stations 2, operates such that the list of the reception target terminals which are present within the set radius around the call connection location is generated and transmitted to the communication control unit 4.

Here, since the operation of the local terminal location storage unit 3 is the same as that of the first embodiment, the detailed description thereof is omitted.

As described above, when the communication control unit 4 receives the list of the reception target terminals which are present within the set radius around the call connection location, the list of the reception target terminals having been transmitted from the local terminal location storage unit 3b, the communication control unit 4 transmits the received list of the reception target terminals to the web server 100. The web server 100 provides the received list of the reception target terminals to the transmission terminal 1, and the list of the reception target terminals, which has been transmitted from the web server 100, is displayed on the screen of the transmission terminal 1 as shown in FIG. 5.

In the state in which the list of the reception target terminals is displayed on the screen of the transmission terminal 1 as shown in FIG. 5, the user selects one or more reception target terminals from the list of the reception target terminals by operating up and down movement keys (not shown) provided in the transmission terminal 1.

If a touch screen function is provided to the transmission terminal 1, the user selects a reception target terminal by touching any one of the reception target terminals which are present in the list of the reception target terminals using his or her finger.

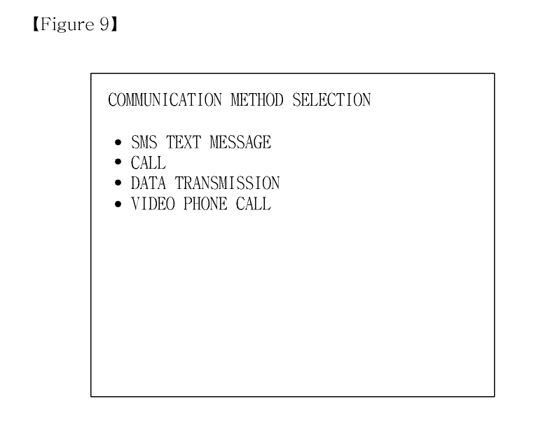

When the user selects one or more reception target terminals by operating the transmission terminal 1, the web server 100 transmits a selection screen, which enables a communication method to be selected, as shown in FIG. 9, to the transmission terminal 1, so that the user selects any one of a “text message”, a “phone call”, “data transmission”, and a “video phone call” using the selection screen which has been transmitted from the web server 100.

When the user selects the “text message” on the selection screen, the web server 100 creates a pop-up window, which enables a text message to be input, on the transmission terminal 1, and the user inputs a text message to be sent using the pop-up window.

The web server 100 transmits the text message input by the user to one or more reception target terminals 5 via the communication control unit 4.

The above-described “text message transmission” communication method is very useful when a specific company transmits text advertising a company to a plurality of recipients in units of a region, and a user can obtain an enormous publicity effect at low cost.

Meanwhile, when the user selects the “phone call” communication method on the selection screen, the web server 100 connects the transmission terminal 1 to a reception target terminal 5 such that a phone call is made. The “phone call” or “video phone call” communication method can be performed only when the user selects a single reception target terminal 5.

The communication control unit 4 operates such that a call signal is transmitted to a reception target terminal 5 over a wireless Internet network, a WiBro network, a wired Internet network, a PSTN, or a wireless communication network based on the communication method of the reception target terminal 5.

When the reception target terminal 5 receives the call signal, a ringtone is generated in the reception target terminal 5. When a recipient who is aware of the ringtone operates the reception target terminal 5 and responds to a call signal, an acknowledge signal is transmitted to the communication control unit over a wired or wireless communication network, so that the transmission terminal 1 and the reception target terminal 5 are connected with each other, and the call is connected.

The user of the transmission terminal 1 connected to the reception target terminal 5 which is present around the specific region (call connection location), that is, the transmitter can obtain information while directly asking about the current situation occurring in the specific region. Further, in the case of a terminal capable of making a video phone call, the transmitter can check images around the region, so that the transmitter can obtain more accurate information.

### Third Embodiment

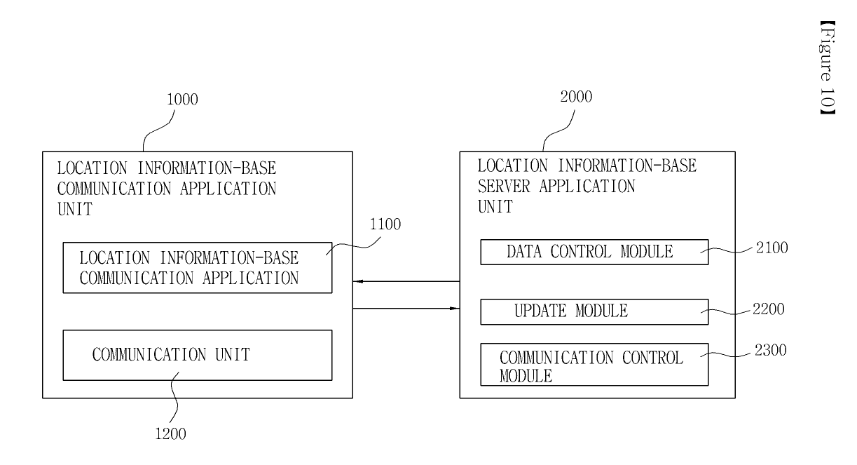

A third embodiment of the present invention illustrated with reference to FIGS. 10 to 23 includes a location information-based communication application unit 1000 installed in a terminal, configured to operate such that the corresponding terminal functions as a transmission terminal or a reception terminal based on location information, configured to output an input screen which enables a user to input information about a call connection location on the screen of the terminal when the terminal functions as a transmission terminal, configured to transmit the information about the call connection location input by the user to a location information-based server application unit 2000, configured to output a list of information about reception target terminals, the list having been received from the location information-based server application unit 2000, on the screen, and configured to transmit information about one or more reception target terminals and a communication method, which are selected by the user, to the location information-based server application unit 2000; and the location information-based server application unit 2000 configured to install the location information-based communication application unit 1000 by downloading a location information-based communication application program to the terminal, configured to, when the information about the call connection location is transmitted from the location information-based communication application unit 1000, transmit the list of information about the reception target terminals which are present around the corresponding call connection location to the location information-based communication application unit 1000, and configured to perform control such that communication is performed based on the information about the reception target terminals and the communication method which were selected by the user and transmitted from the location information-based communication application unit 1000.

The location information-based communication application unit 1000 includes a location information-based communication application 1100 installed in the terminal, configured to make the corresponding terminal to function as a transmission terminal or a reception terminal, and configured to enable information about a call connection location, a reception target field, and a communication method to be selected when the terminal functions as a transmission terminal; and a communication unit 1200 configured to communicate over the wireless Internet or a telephone network, configured to receive the location information-based communication application program from the location information-based server application unit 2000 and to install the location information-based communication application program in the terminal, and configured to transmit data which is output from the location information-based communication application 1100 to the location information-based server application unit 2000.

The location information-based communication application 1100 includes a location information input application 1110 for displaying a call connection mode input screen on the screen of the terminal, the call connection mode input screen enabling the information about the call connection location, used for call connection, to be input in a coordinate input mode, an address input mode, a road name input mode, a building name input mode, or a map input mode; a reception target field selection application 1120 for displaying a target field selection screen on the screen of the terminal, the target field selection screen enabling a transmitter to select the target field (category) of a desired communication recipient when connection is requested based on the location information; a communication method selection application 1130 for displaying a communication method selection screen on the screen of the terminal, the communication method selection screen enabling the transmitter to select any one of communication methods from among a “voice call”, a “video phone call”, a “text message”, and “data transmission” when the transmitter communicates with the target recipient; and a reception application 1140 for making the corresponding terminal to function as a reception terminal, displaying a reception selection screen on the screen of the terminal, the reception selection screen enabling a recipient to select call acceptation or call rejection when a call is requested by the transmission terminal based on the location information.

A location information-based communication application apparatus according to the present invention is installed in a wired or wireless terminal, such as a mobile phone, a smart phone, a tablet PC or a notebook computer, which can make a voice call or a video phone call and can perform data communication, and is configured to make the corresponding terminal to function as a transmission terminal or a reception terminal. When the user accesses the location information-based server application unit 2000 using the terminal and downloads the location information-based communication application program, the location information-based communication application unit 1000 is installed in the terminal.

The location information-based communication application unit 1000 installed in the terminal includes the location information-based communication application 1100 and the communication unit 1200.

The location information-based communication application 1100 includes the location information input application 1110, the reception target field selection application 1120, the communication method selection application 1130, and the reception application 1140. The communication unit 1200 performs a function of communicating with the location information-based server application unit 2000 using data.

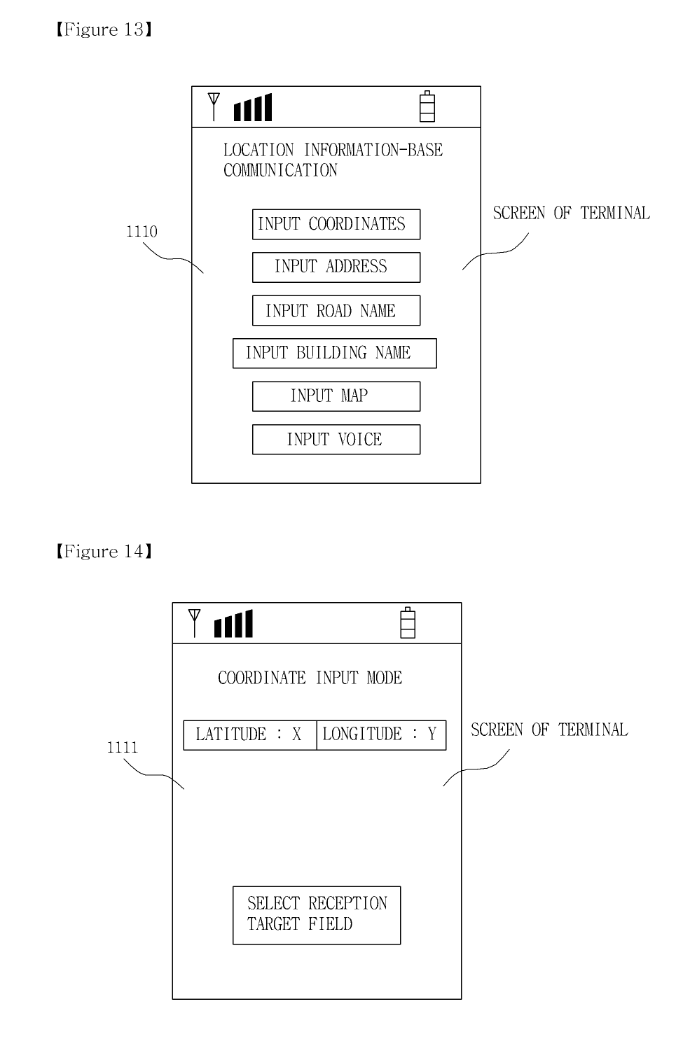

When the user of the terminal executes the location information-based communication application unit 1000, the location information input application 1110 operates, thereby displaying an initial screen, as shown in FIG. 13, used to perform location information-based communication, on the screen of the terminal.

The initial screen displays a coordinate input icon, an address input icon, a road name input icon, a building name input icon and a map input icon which enable information about a call connection location used to request location information-based call connection.

When the user selects the coordinate input icon, a coordinate input mode 1111 operates so that a coordinate input mode screen, as shown in FIG. 14, is displayed on the terminal. The user inputs latitude and longitude corresponding to the information about the call connection location used to request call connection. In the coordinate input mode 1111, information about the latitude and longitude input by the user is stored in the location information-based communication application 1100.

When the user selects the address input icon, an address input mode 1112 operates so that an address input mode screen, as shown in FIG. 15, is displayed on the terminal. The user inputs an address corresponding to the information about the call connection location used to request call connection into an address input window. In the address input mode 1112, information about the address input by the user is stored in the location information-based communication application 1100.

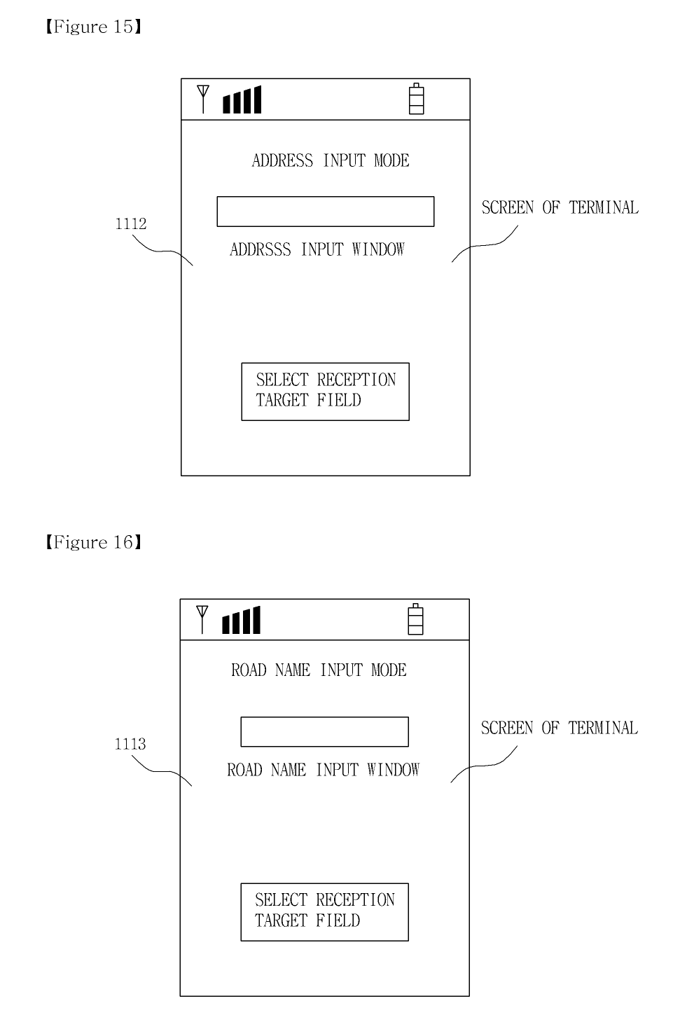

When the user selects the road name input icon, a road name input mode 1113 operates so that a road name input mode screen, as shown in FIG. 16, is displayed on the terminal. The user inputs a road name corresponding to the information about the call connection location used to request call connection into a road name input window. In the road name input mode 1113, information about the road name input by the user is stored in the location information-based communication application 1100.

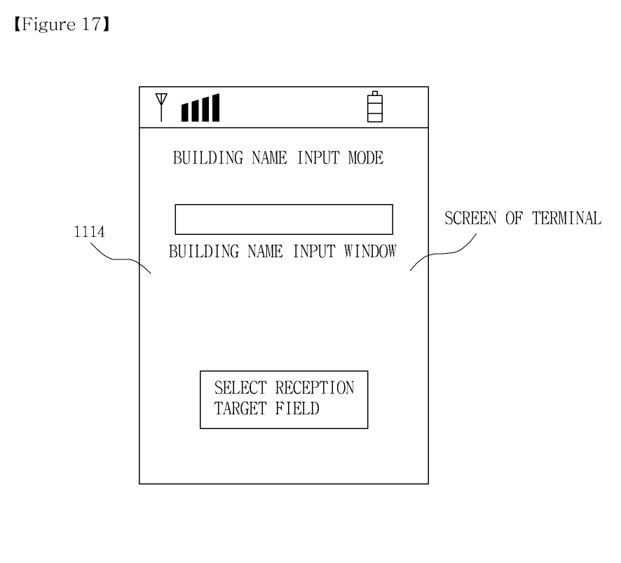

When the user selects the building name input icon, the building name input mode 1114 operates so that a building name input mode screen, as shown in FIG. 17, is displayed on the terminal. The user inputs a building name corresponding to the information about the call connection location used to request call connection into a building name input window. In the building name input mode 1114, information about the building name input by the user is stored in the location information-based communication application 1100.

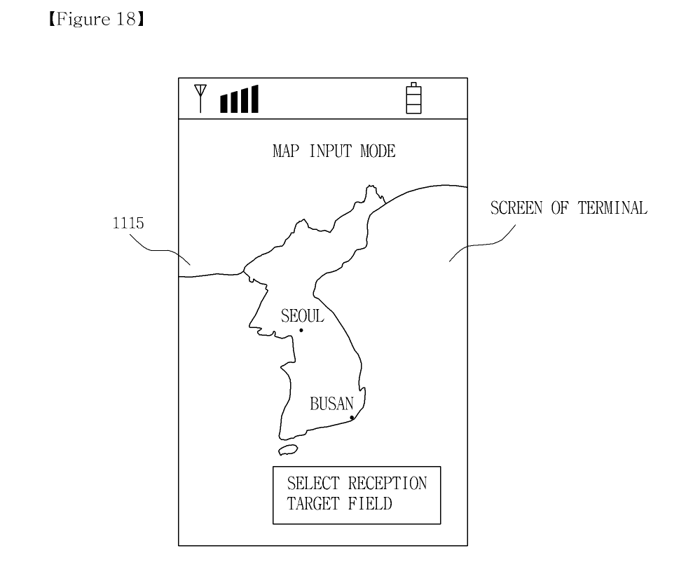

When the user selects the map input icon, a map input mode 1115 operates so that a map input mode screen, as shown in FIG. 18, is displayed on the terminal. The user performs input by touching a location corresponding to the information about the call connection location used to request call connection on the map. In the map input mode 1115, information about latitude and longitude corresponding to the location which the user touched is stored in the location information-based communication application 1100.

When the user selects a voice input icon, a voice input mode 1116 operates so that guidance message “say a building name or a location name corresponding to information about a call connection location” is displayed on the screen. If the user says a building name or a location name, the voice is recognized in the voice input mode 1116, and then information about latitude and longitude corresponding to the corresponding location is stored in the location information-based communication application 1100.

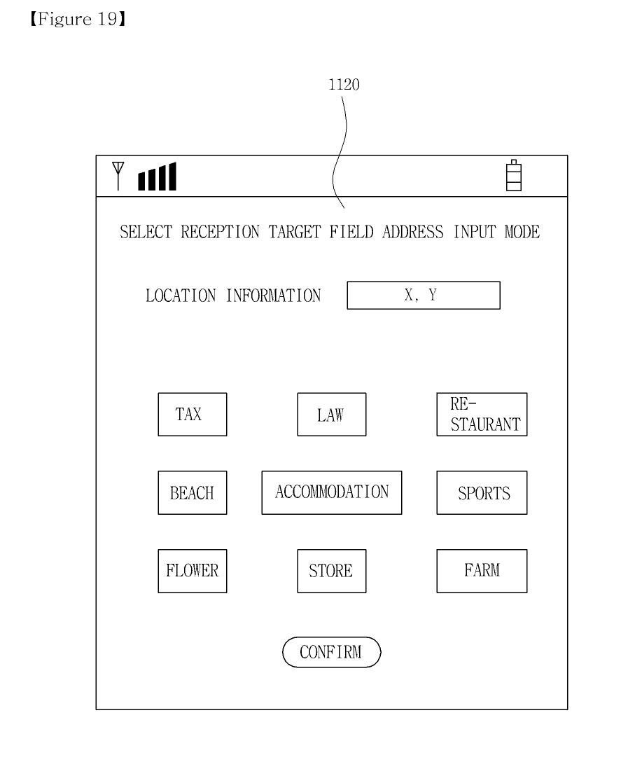

A reception target field selection icon is displayed at the bottom of the above-described input screens used to input information about a call connection location (refer to FIGS. 14 to 18). When the user inputs information about a call connection location and then selects the reception target field selection icon, the reception target field selection application 1120 operates, thereby displaying selection buttons corresponding to reception target fields which can be selected by the user, that is, “tax”, “law”, “restaurant”, “beach”, “fishing”, “accommodation”, “sport”, “flower shop”, and “farm”, as shown in FIG. 19. If the user selects any one of the reception target fields, reception target terminals, which are included in the reception target field and which are present around a call connection location input by the user, are provided to the transmitter in the form of a list of the reception target terminals.

The reception target fields are registered and stored in advance.

The transmitter can proceed to a subsequent step without selecting a reception target field.

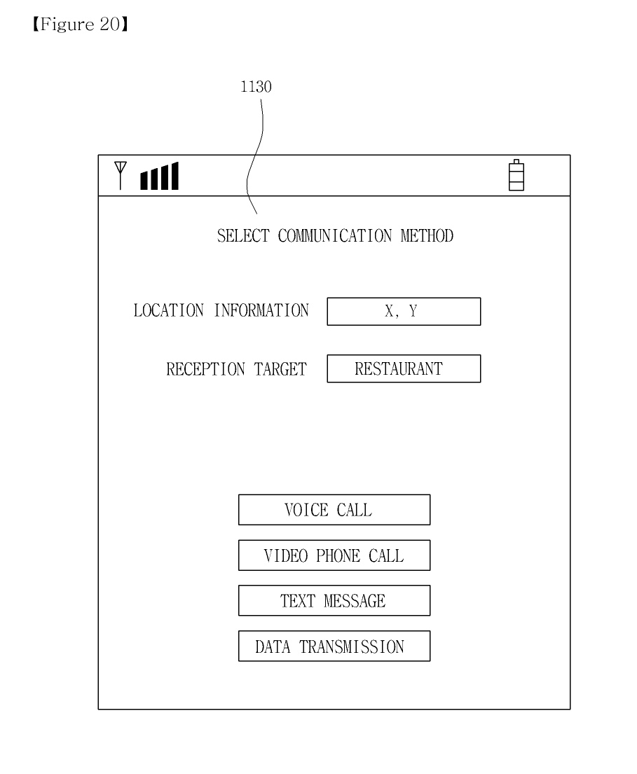

If the transmitter proceeds to a subsequent step without selecting a reception target field, the communication method selection application 1130 operates so that information about a call connection location (X, Y) and a reception target which have been selected before by the transmitter are displayed, at the same time, the communication method selection screen which enables a communication method (voice call, video phone call, text message, or data communication) to be selected is output on the screen of the terminal, as shown in FIG. 20.

If the user selects a specific call method from on the communication method selection screen, the location information-based communication application 1100 transmits information about the call connection location, a reception target, and a communication method which are selected by the transmitter to the location information-based server application unit 2000 using the communication unit 1200. Thereafter, if the list of the reception targets is received from the location information server application unit 2000, the location information-based server application unit 2000 displays the list of the reception targets on the screen of the terminal such that the user selects any one or more reception targets. If the user selects any one or more reception target terminals, the location information-based server application unit 2000 tries to connect a call to the corresponding reception target terminals, so that a voice call, a video phone call, or text message transmission is implemented.

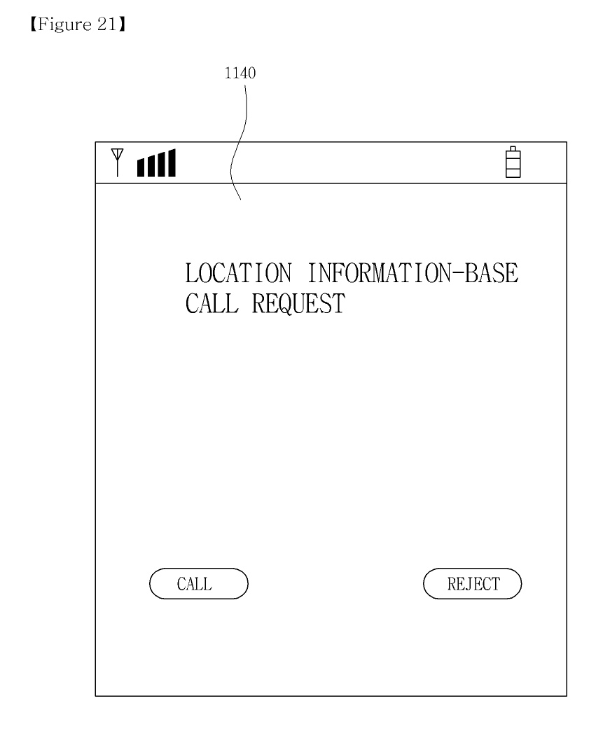

FIG. 21 illustrates an operational example in which a terminal provided with the location information-based communication application unit 1000 functions as a reception terminal. When a location information-based call request is received, the reception application 1140 operates, thereby outputting a screen, which enables call acceptation or call rejection to be selected, together with a message “location information-based call request” as shown in FIG. 21. A recipient can accept a call or reject the call from a transmitter, who has requested location information-based call connection, using the screen.

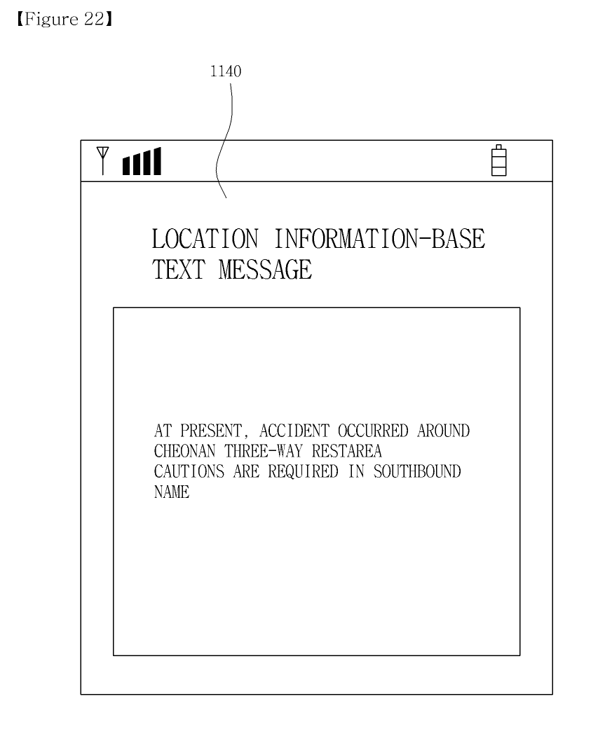

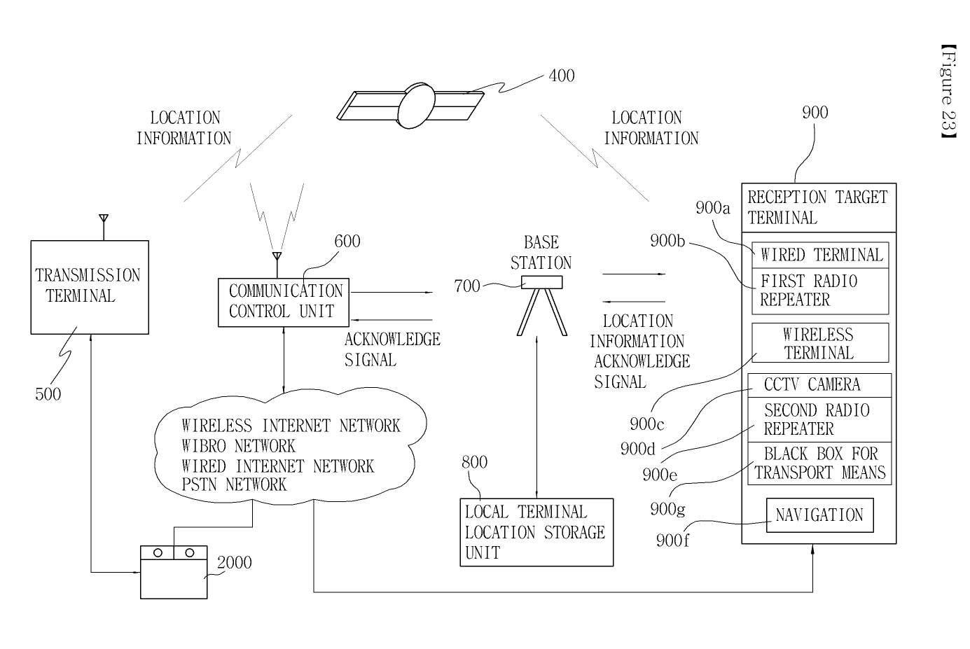

FIG. 22 illustrates an example in which a location information-based text message is transmitted from a transmitter and displayed on the terminal of a recipient.

Meanwhile, the location information-based server application unit 2000 includes a data control module 2100 for storing and transmitting a location information-based communication application program to be downloaded to the location information-based communication application unit 1000; an update module 2200 for updating the latest location information-based communication application program while periodically communicating with the location information-based communication application unit 1000; and a communication control module 2300 for exchanging data with the location information-based communication application unit 1000, and communicating with a communication control unit 600 which is included in a communication network when the location information-based communication application unit 1000 requests call connection, thereby performing control such that location information-based communication is implemented.

Meanwhile, FIG. 23 illustrates an overall communication network which includes the location information-based communication application apparatus according to the present invention, and the location information-based communication application apparatus includes a transmission terminal 500 configured to be able to perform wired or wireless Internet communication, configured to have a phone function and an image display function, and provided with the location information-based communication application unit 1000; one or more reception target terminals 900 each configured to receive location information transmitted from a satellite 400 and to transmit the location information to a base station 700, and provided with the location information-based communication application unit 1000; the base station 700 configured to connect the reception target terminals 900 with the communication control unit 600; a local terminal location storage unit 800 configured to receive pieces of location information transmitted from the reception target terminals 900 via the base station 700, and configured to store information about the locations of the reception target terminals 900 which are present within a local area; a location information-based server application unit 2000 configured to transmit information about a call connection location, information about the reception target terminals and a communication method, which are selected by the transmission terminal 500, to the communication control unit 600, and, when the communication method selected by the transmission terminal 500 is a text message, configured to transmit a text message which is input using the transmission terminal 500 to the reception target terminals using the communication control unit 600; and the communication control unit 600 configured to receive a list of the reception target terminals 900 which are present around the corresponding call connection location from the local terminal location storage unit 800 in response to a call signal based on the information about the call connection location, which was transmitted from the location information-based server application unit 2000, configured to transmit the list of the reception target terminals 900 to the location information-based server application unit 2000, and configured to perform control such that the transmission terminal 500 communicates with the reception target terminals 900 by connecting the corresponding reception target terminals 900 over a wired or wireless communication network (for example, a wireless Internet network, a WiBro network, a wired Internet network, or a PSTN) in response to the call signal which is transmitted when specific reception target terminals are selected by the transmission terminal 1000.

The terminals are classified as the transmission terminal 500 and the reception target terminal 900 based on the functions of the terminals as the transmission terminal and the reception terminal, and the terminals are actually the same.

Such a terminal includes any one of a wired terminal 900a which is connected to a first radio repeater 900b capable of communicating with the base station 700, receiving GPS location information from the satellite 400 and transmitting the GPS location information to the base station 700; a wireless terminal 900c which can receive GPS location information from the satellite 400 and can make a call; a CCTV camera 900d which is connected to a second radio repeater 900e capable of communicating with the base station 700, receiving GPS location information from the satellite, transmitting the GPS location information to the base station, and receiving a phone number used for call connection; a navigation unit 900f which is capable of receiving GPS location information from the satellite 400 and capable of making a wireless call, and which is provided with a camera; a black box which is provided with a camera connected to a second radio repeater 900e capable of communicating with the base station 700, capable of receiving GPS location information from the satellite 400 and transmitting the GPS location information to the base station 700, and having been assigned a phone number used for call connection; a mobile phone; a smart phone; and a tablet PC.

The operation of the location information-based communication application apparatus according to the present invention will be described in connection with the overall communication network as shown in FIG. 23.

First, when the user selects information about a call connection location, a reception target field, and a communication method using the location information-based communication application unit 1000 installed in the transmission terminal 500 and then transmits the selected items to the location information-based server application unit 2000, the location information-based server application unit 2000 transmits the information about the call connection location to the communication control unit 600. The communication control unit 600 of a communication company requests that the local terminal location storage unit 800, which is in charge of the corresponding call connection location, transmit a list of reception target terminals 900 which are present within the set radius around the call connection location corresponding to the information about the call connection location. The communication control unit 600 receives a list of information about the reception target terminals, which was transmitted from the local terminal location storage unit 800 in response to the request from the communication control unit 600.

The communication control unit 600 transmits the information about the call connection location to all the base stations 700. Thereafter, from among local terminal location storage units 800 connected to the corresponding base stations 700, a local terminal location storage unit 800 which is in charge of a local area including the corresponding call connection location operates, thereby generating a list of the reception target terminals which are present within the set radius around the call connection location, and transmitting the generated list of the reception target terminals to the communication control unit 600. The communication control unit 600 transmits the list of the reception target terminals to the transmission terminal 500 using the location information-based server application unit 2000.

If a transmitter selects a reception target field, the location information-based server application unit 2000 directly transmits the reception target of the reception target field, which is close to the corresponding call connection location selected from the list of the reception targets which is stored in the data control module 2100, to the transmission terminal 500.

In the state in which the list of the reception target terminals is displayed on the screen of the transmission terminal 500, the user operates the transmission terminal 500 and selects one or more reception target terminals from the list of the reception target terminals. The location information-based server application unit 2000 connects the transmission terminal 500 and reception target terminals 900 which were selected by the transmission terminal 500 such that a call is connected between the transmission terminal 500 and each of the reception target terminals 900.

The communication control unit 600 operates such that a call signal is transmitted to the reception target terminal 900 over a wireless Internet network, a WiBro network, a wired Internet network, a PSTN, and wireless communication network based on the communication method of the reception target terminal 900.

The user of the transmission terminal 500 connected to the reception target terminals 900 which are present around a specific region (call connection location), that is, a transmitter can obtain information while directly asking about the current situation occurring in the specific region. Further, in the case of a terminal capable of making a video phone call, the transmitter can check images around the region, so that the transmitter can obtain more accurate information.

Further, the transmitter can check images captured by a vehicle's black-box camera or a navigation camera by connecting to a moving vehicle's black-box camera or a navigation camera.

Further, the transmitter can check images captured by a CCTV using a wireless terminal by connecting to the CCTV installed in the specific region.

When the above-described communication method of using location information as a call signal according to the present invention is used, the advantage is obtained of a long-distance user being able to rapidly and quickly obtain detailed information about a festival which is taking place in another region or a big accident which occurred in another region.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A location information-based communication method, comprising:
a first step in which a communication control unit of a communication company receives information about a call connection location (reception target location information) used for call connection from a transmission terminal;
a second step in which the communication control unit requests a list of information about reception target terminals, which exist around the call connection location corresponding to the information about the call connection location, from a local terminal location storage unit which is in charge of the corresponding call connection location, and the communication control unit receives the list of information about the reception target terminals, which has been transmitted from the local terminal location storage unit in response to the request;
a third step in which the communication control unit transmits the list of information about the reception target terminals, which was received in the second step, to the transmission terminal and waits for reception of a call signal; and
a fourth step in which the communication control unit receives the call signal transmitted in such a way that a user of the transmission terminal selects any one or more reception target terminals from the list of information about the reception target terminals, and connects the transmission terminal to the reception target terminals by connecting to phone numbers of the reception target terminals corresponding to the received call signal over a wired or wireless communication network.

2. A location information-based communication method, comprising:
a first step in which a web server transmits a call connection location information input screen, which enables information about a call connection location used for call connection to be input or selected, to a transmission terminal of a user, which has accessed the web server over an Internet;
a second step in which the web server receives the information about the call connection location, which was input or selected by the user using the call connection location information input screen, transmits the information about the call connection location to a communication control unit, and requests a list of information about reception target terminals;
a third step in which the communication control unit receives the list of information about the reception target terminals from a local terminal location storage unit, and transmits the received list of information about the reception target terminals to the web server at the request of the web server, and in which the web server transmits the received list of information about the reception target terminals to the transmission terminal; and
a fourth step in which the web server receives information which had been transmitted in such a way that the user selects one or more reception target terminals using the list of information about the reception target terminals and selects a desired communication method, and in which the web server transmits information using the communication method, selected by the user from among a text message, a phone call and data communication, to the reception target terminals selected by the user or enables a call to be made.

3. The location information-based communication method according to claim 1 or 2, wherein the local terminal location storage unit receives pieces of location information which have been received from reception target terminals which are present in a local area in each predetermined period via a base station, stores the pieces of location information, generates the list of information about the reception target terminals by collecting the reception target terminals which are present within a set radius around the call connection location corresponding to the information about the call connection location when the information about the call connection location is received from the communication control unit, and then transmits the list of information about the reception target terminals to the communication control unit.

4. The location information-based communication method according to claim 1 or 2, wherein each of the reception target terminals comprises any one of:
a wired terminal which is connected to a first radio repeater capable of communicating with the base station, capable of receiving Global Positioning System (GPS) location information from satellites, and capable of transmitting the GPS location information to the base station;
a wireless terminal which can receive GPS location information from satellites, and which can make a call;
a Closed-Circuit Television (CCTV) camera which is connected to a second radio repeater capable of communicating with the base station, capable of receiving GPS location information from satellites, capable of transmitting the GPS location information to the base station, and having been assigned a phone number used for call connection;
a navigation unit which can receive GPS location information from satellites, and which can make a wireless call;
a black box for transport means which is provided with a camera connected to the second radio repeater capable of communicating with the base station, capable of receiving GPS location information from satellites and transmitting the GPS location information to the base station, and having being assigned the phone number used for call connection;
a mobile phone;
a smart phone; and
a tablet Personal Computer (PC).

5. The location information-based communication method according to claim 1 or 2, wherein, when the communication control unit requests the list of the reception target terminals around the call connection location (reception target location) from the local terminal location storage unit and a response from the local terminal location storage unit is that there is no reception target terminal within a set radius around the corresponding call connection location, the communication control unit requests the local terminal location storage unit to extend the set radius by a predetermined distance, and the local terminal location storage unit extends the set radius around the call connection location in response to the request from the communication control unit, generates a list of reception target terminals which are present within the extended set radius, and transmits the generated list of the reception target terminals to the communication control unit.

6. The location information-based communication method according to claim 1 or 2, wherein the information about the call connection location comprises any one of address information and location coordinates (X, Y) including latitude and longitude.

7. The location information-based communication method according to claim 1 or 2,
wherein the call connection location information input screen includes a target field selection screen which enables the user to select a desired communication target field (category);
wherein the target field selection screen displays field pop-up windows which indicate various types of fields; and
wherein, when a specific field pop-up window is selected, the web server provides a list of information about reception targets, which have been registered in a relevant field in advance at a location corresponding to the information about the call connection location selected by the user, to the transmission terminal.

8. The location information-based communication method according to claim 2, wherein, if the communication method selected by the user is Short Message Service (SMS) text message transmission, the web server provides an input screen which enables the user to input a text message, and transmits the text message input using the input screen to the communication control unit, so that the text message is transmitted to the reception target terminals.

9. The location information-based communication method according to claim 2, wherein the transmission terminal is a terminal capable of performing wired or wireless Internet communication, and comprises any one of a mobile phone, a PC, a Personal Digital Assistant (PDA), a smart phone, a tablet PC, a satellite phone, and a notebook computer.

10. A location information-based communication apparatus, comprising:
a transmission terminal for transmitting information about a call connection location selected by a user to a communication control unit, outputting a list of information about one or more reception target terminals, which are present around the call connection location received from the communication control unit, on a screen, and transmitting a call signal which targets any one or more reception target terminals selected from the list of information about the reception target terminals to the communication control unit;
the communication control unit for receiving the list of the reception target terminals around the call connection location corresponding to the information about the call connection location, which was received from the transmission terminal, from a local terminal location storage unit which is in charge of a relevant reception target location, transmitting the list of information about the reception target terminals to the transmission terminal, and connecting the transmission terminal to desired reception target terminals by connecting to phone numbers of the reception target terminals corresponding to the call signal transmitted from the transmission terminal over a wired or wireless communication network;
a local terminal location storage unit for receiving pieces of location information received from reception target terminals present within a local area in each predetermined period via a base station, storing the pieces of location information, generating the list of information about the reception target terminals by collecting the reception target terminals within a set radius around the call connection location (reception target location) corresponding to the information about the call connection location when the information about the call connection location is received from the communication control unit, and transmitting the generated list of information about the reception target terminals to the communication control unit; and
the reception target terminals for each receiving location information from satellites and transmitting the location information to the base station.

11. A location information-based communication apparatus, comprising:
a transmission terminal for being able to perform wired or wireless Internet communication, accessing a web server over an Internet, selecting one or more reception target terminals from a list of information about reception targets provided by the web server and a communication method of communicating with the selected reception target terminals, transmitting information about the selected reception target terminals and the communication method to the web server, and communicating with the reception target terminals connected by the web server;
the web server for providing a call connection location information input screen, which enables information about a call connection location to be input or selected, to the transmission terminal accessed over the Internet, transmitting information about the call connection location, which was input using the call connection location information input screen, to the communication control unit, outputting a list of information about reception target terminals around the call connection location to the screen of the transmission terminal 1, the list of information about the reception target terminals transmitted by the communication control unit, and transmitting a call signal, which targets any one or more reception target terminals which are selected from the list of information about the reception target terminals using the transmission terminal, to the communication control unit;
the communication control unit for receiving the list of information about the reception target terminals around the call connection location corresponding to the information about the call connection location, the list of information about the reception target terminals being transmitted from the web server, from the local terminal location storage unit which is in charge of a relevant reception target location, transmitting the list of information about the reception target terminals to the web server, and connecting the transmission terminal to the reception target terminals by connecting to phone numbers of the reception target terminals corresponding to the call signal transmitted by the web server over a wired or wireless communication network;
the local terminal location storage unit for receiving and storing pieces of location information transmitted from reception target terminals within a local area in each predetermined period via a base station, and, if the information about the call connection location is transmitted from the communication control unit, collecting information about the reception target terminals within a set radius around the call connection location (reception target location) corresponding to the information about the call connection location, generating the list of information about the reception target terminals, and transmitting the list of information about the reception target terminals to the communication control unit; and
the reception target terminals for receiving the pieces of location information transmitted from satellites, and transmitting the pieces of location information to the base station.

12. A location information-based communication application apparatus, comprising:
a location information-based communication application unit installed in a terminal, configured to function as a transmission terminal or a reception terminal based on location information, configured to output an input screen which enables a user to input information about a call connection location on a screen of the terminal when the terminal functions as a transmission terminal, configured to transmit the information about the call connection location input by the user to a location information-based server application unit, configured to output a list of information about reception target terminals on the screen, the list having been received from the location information-based server application unit, and configured to transmit information about one or more reception target terminals and a communication method, which are selected by the user, to the location information-based server application unit; and
the location information-based server application unit configured to install the location information-based communication application unit by downloading a location information-based communication application program to the terminal, configured to, when the information about the call connection location is transmitted from the location information-based communication application unit, transmit the list of information about the reception target terminals around the corresponding call connection location to the location information-based communication application unit, and configured to perform control such that communication is performed based on the information about the reception target terminals and the communication method which were selected by the user and transmitted from the location information-based communication application unit.

13. The location information-based communication application apparatus according to claim 12, wherein the location information-based communication application unit comprises:
a location information-based communication application installed in the terminal, configured to make the corresponding terminal to function as a transmission terminal or a reception terminal, and configured to enable information about the call connection location, a reception target field, and a communication method to be selected when the terminal functions as a transmission terminal; and
a communication unit configured to communicate over a wireless Internet or a telephone network, configured to receive the location information-based communication application program from the location information-based server application unit, and to install the location information-based communication application program in the terminal, and configured to transmit data output from the location information-based communication application to the location information-based server application unit.

14. The location information-based communication application apparatus according to claim 12, wherein the location information-based communication application comprises:
a location information input application for displaying a call connection mode input screen on the screen of the terminal, the call connection mode input screen enabling the information about the call connection location used for call connection to be input in a coordinate input mode, an address input mode, a road name input mode, a building name input mode, or a map input mode;
a reception target field selection application for displaying a target field selection screen on the screen of the terminal, the target field selection screen enabling a transmitter to select a target field (category) of a desired communication recipient when connection is requested based on the location information;
a communication method selection application for displaying a communication method selection screen on the screen of the terminal, the communication method selection screen enabling the transmitter to select any one of communication methods from among a “voice call”, a “video phone call”, a “text message”, and “data transmission” when the transmitter communicates with a target recipient; and
a reception application for causing the corresponding terminal to function as a reception terminal, and displaying a reception selection screen on the screen of the terminal, the reception selection screen enabling the recipient to select call acceptation or call rejection when a call is requested by the transmission terminal based on the location information.

15. The location information-based communication application apparatus according to claim 12, wherein the location information-based server application unit comprises:
a data control module for storing and transmitting the location information-based communication application program to be downloaded to the location information-based communication application unit;
an update module for updating a latest location information-based communication application program while periodically communicating with the location information-based communication application unit; and
a communication control module for exchanging data with the location information-based communication application unit, and communicating with a communication control unit included in a communication network when the location information-based communication application unit requests a call connection, thereby performing control such that location information-based communication is implemented.

16. The location information-based communication application apparatus according to claim 12, wherein the terminal comprises any one of:
a wired terminal which is connected to a first radio repeater capable of communicating with a base station, and capable of receiving GPS location information from satellites and transmitting the GPS location information to the base station;
a wireless terminal which can receive GPS location information from satellites and which can make a call;
a CCTV camera which is connected to a second radio repeater capable of communicating with the base station, capable of receiving GPS location information from satellites, capable of transmitting the GPS location information to the base station, and having been assigned a phone number used for call connection;
a navigation unit which is capable of receiving GPS location information from satellites, which is capable of making a wireless call, and which is provided with a camera;
a black box for transport means which is provided with a camera connected to a second radio repeater capable of communicating with the base station, capable of receiving GPS location information from satellites and transmitting the GPS location information to the base station, and having been assigned a phone number used for call connection;
a mobile phone;
a smart phone; and
a tablet PC.
